(19) United States
(12) Patent Application Publication
(10) Pub. No.: US 2005/0166431 A1
(43) Pub. Date: Aug. 4, 2005

(54) Advertising display unit

(75) Inventors: Andrew J. Boron, Belleville, IL (US); Gary P. George, St. Louis, MO (US); Kent L. Hanners, St. Charles, MO (US)

Correspondence Address: BLACKWELL SANDERS PEPER MARTIN LLP, 720 OLIVE STREET, SUITE 2400, ST. LOUIS, MO, 63101, US

(73) Assignee: Paul Flum Ideas, Inc., St. Louis, MO (US)

(21) Appl. No.: 10/708,041

(22) Filed: Feb. 4, 2004

(51) Int. Cl. G09F 7/02

(52) U.S. Cl. 40/607.03; 40/618; 40/606.18

(57) ABSTRACT

An advertising display unit adaptable for attachment to a guard structure such as upright supports located adjacent the fuel pump islands associated with a typical service station, the present display unit including a sign structure having a pair of generally opposed display panels positioned in spaced apart relationship so as to form a cavity adaptable for receiving the guard structure. Each display panel includes an attachment structure for removably securing the sign structure to the guard structure so as to retain the display unit in a generally upright orientation. In a preferred embodiment, the attachment structure includes a plurality of openings associated with each display panel and a plurality of tie members or cable straps positionable through selected openings for pulling a portion of each display panel into engagement with the guard structure.

### BACKGROUND OF INVENTION

The present invention relates to an advertising display unit for use in combination with a guard structure like those found at service stations generally adjacent to a gas pump island.

It is common to advertise at retail outlets in any space available. Often, a store will charge an advertiser to display ads or other promotional material with the price charged being determined by the location of the ad or other materials in or around the store environment. Such modes of advertising include posters for windows and doors, free standing signs, product displays and shelf talkers amongst others. Such advertising can be placed inside or outside a retail outlet depending upon the merchandising environment and opportunity. The more visible the advertising signage, the more effective will be the possibility of impulsed sales. Placing advertising on or in the vicinity of the exterior of a retail establishment can be problematic due to weather conditions, wind, traffic and other such factors.

One means of displaying advertising outside of a retail outlet is to place the advertising on a sign panel that is secured to a base. However, wind can easily turn such displays over which can cause damage to the sign and which requires personnel to reset and/or repair the display. Some displays utilize spring mounted advertising panels to help resist the wind but they are complicated and expensive. Some displays need to be movable, and thus it is inconvenient to secure them to the ground or to the structure of the retail outlet to prevent damage or loss. Additionally, securement can also be expensive and can cause damage to the property such as drilling holes or attaching other structures to property. Further, retail outlets typically do not have the tools necessary to secure an advertising display in place nor do they generally have personnel skilled to effect such securement. Weights can also be used to fix or hold such displays in place, however, the use of weights likewise make the panels difficult to move and add additional cost to the displays.

It is thus desirable to have advertising signage in position for ready and convenient viewing that is difficult for consumers to avoid but yet easy to install and maintain. In the case of service stations, cars will drive to positions adjacent fuel pumps and purchase fuel, often paying for the fuel at the pump. This type of consumer has little if any need to enter the retail outlet and view advertising located in or directly associated with the walls or walkways of the establishment. In this environment, it would be desirable to have advertising positioned adjacent to the fuel pumps but out of the way of vehicle traffic to and away from the pumps. The use of such advertising adjacent to the fuel pumps can be used to induce customers to buy additional items particularly those in the impulse category such as soft drinks, snacks, and certain automotive products. However, attaching advertising to or adjacent the fuel pumps is problematic. As previously discussed, the known prior art signs are not totally conducive to inclement weather conditions, especially wind, and such nonanchored signs may also cause damage to vehicles parked adjacent the fuel pumps.

There is thus a need for an advertising display that is inexpensive and can be mounted or secured in place to a suitable structure positioned adjacent the fuel pumps or exterior of the retail outlet. The advertising display should be easy to install and remove and should also provide the ability to change the advertising message thereon.

### SUMMARY OF INVENTION

The present invention relates to an advertising display unit adapted to be removably secured to existing structure at a retail outlet. The existing structure may include a vehicle guard positioned at exposed ends of the fuel pump islands associated with a typical service station. Other suitable structures may likewise be utilized. The present advertising display unit includes a pair of opposed display panels with a web structure secured thereto and extending therebetween forming a hollow cavity within the interior of the sign structure. The sign structure may be adjustable in spacing between the display panels to accommodate guard structures of different or varying sizes. An attachment structure is also provided to permit the removable attachment of the sign structure to the guard structure with the attachment structure being adapted for securing the sign structure to a plurality of different sized, shaped and constructed guard structures. A spacer may be provided for positioning in the interior of the sign structure to prevent the display panels from moving toward one another and for providing additional stability and rigidity thereto. The sign structure may also include means for releasably securing advertising materials and pricing information to the sign structure.

### BRIEF DESCRIPTION OF DRAWINGS

FIG. 1 is a perspective view of one embodiment of the present advertising display sign unit constructed in accordance with the teachings of the present invention and shown mounted to a vehicle guard structure located adjacent to fuel pumps at a typical service station or other retail outlet.

FIG. 2 is an enlarged perspective view of the present display unit with portions broken away to show interior details of the display unit and the vehicle guard structure to which it is secured.

FIG. 3 is an exploded perspective view of the present display unit.

FIG. 4 is an elevational view of one of the main display panels associated with the present display unit.

FIG. 5 is a plan view of a top web member that is positioned between two main display panels in use.

FIG. 6 is an enlarged fragmentary perspective view of the display panel of FIG.

FIG. 7 is an enlarged fragmentary perspective view of the top web member, a side member and a display panel to show their interconnection.

FIGS. 8A-D are fragmentary perspective views of alternate embodiments of the present display unit.

### DETAILED DESCRIPTION

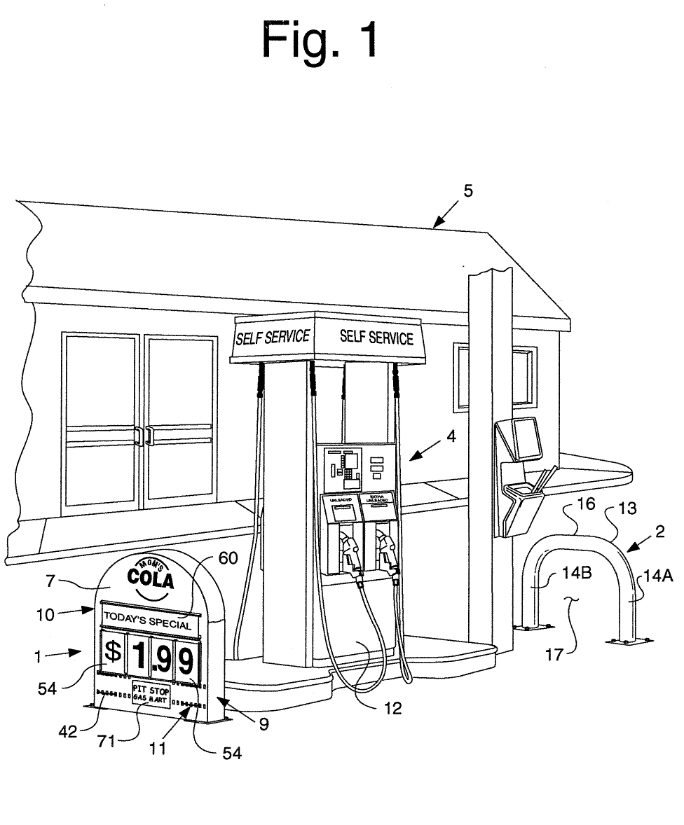

Referring to the drawings more particularly by reference numbers wherein like numerals refer to like parts, the referenced numeral 1 in FIG. 1 designates generally an advertising display unit that is adapted to be removably mounted to a guard structure 2 such as a vehicle guard positioned and secured in place exterior of a retail outlet 5 such as a service station with pump islands 4. The display unit 1, in the illustrated structure, includes a plurality of generally opposed display panels 7 secured to and held in spaced relation to each other by a web structure 9. The web structure 9 and display panels 7 form a sign structure 10. An attachment structure, designated generally 11, is provided and is operably associated with the sign structure 10 to removably attach the sign structure to a guard structure such as guard structure 2 or the like.

The guard structure 2 may be in the form of a rigid member 13 which is set or embedded in or otherwise suitable secured to the ground so as to fixedly secure the guard structure in place and provide protection for some portion of the retail outlet 5, for example, the fuel or gas pumps 12. A guard structure 2 may also be provided adjacent to parking spots, as for example, at the front of the outlet 5. Although the preset advertising display unit is described in terms of its utilization at a typical service station, which may include a convenience store, restaurant or the like, the present display unit 1 may also be utilized with any form of retail store or outlet.

The rigid guard member 13 may be in the form of an upstanding round tubular member that may be in the shape of an inverted generally U-shaped structure having two upright leg members 14A and 14B. The uprights 14A and 14B may be inter-connected by a bight member 16 which extends between the uprights 14A and 14B as best illustrated in FIG. 1. In a preferred structure, the rigid guard member 13 is an integral structure formed by bending a tubular member to the desired shape. The bight 16 may be arcuate or straight. There is an open space 17 between the bight 16 and the uprights 14A and 14B. Although the guard members 13 typically in use are generally tubular in shape, it is recognized that such member may take on any cross-sectional shape such as square, rectangular, and so forth. Generally such guard structures 2 are positioned at the opposite and exposed ends of the pump islands 4 to protect the pump islands 4 from damage by vehicles. Although a generally U-shaped guard structure 2 is shown, it is also recognized and understood that just the two uprights 14A and 14B may be used as a guard structure without a bight portion 16 extending therebetween. A single upright 14 may also be used, although in this event, it is preferred that the transverse cross-section be such as to prevent rotation of the sign structure 10 thereabout, for example, a rectangular or square cross section. Even though multiple forms of guard structures 2 may be accommodated, the preferred guard structure for use with the present display unit 1 has at least two spaced apart uprights 14.

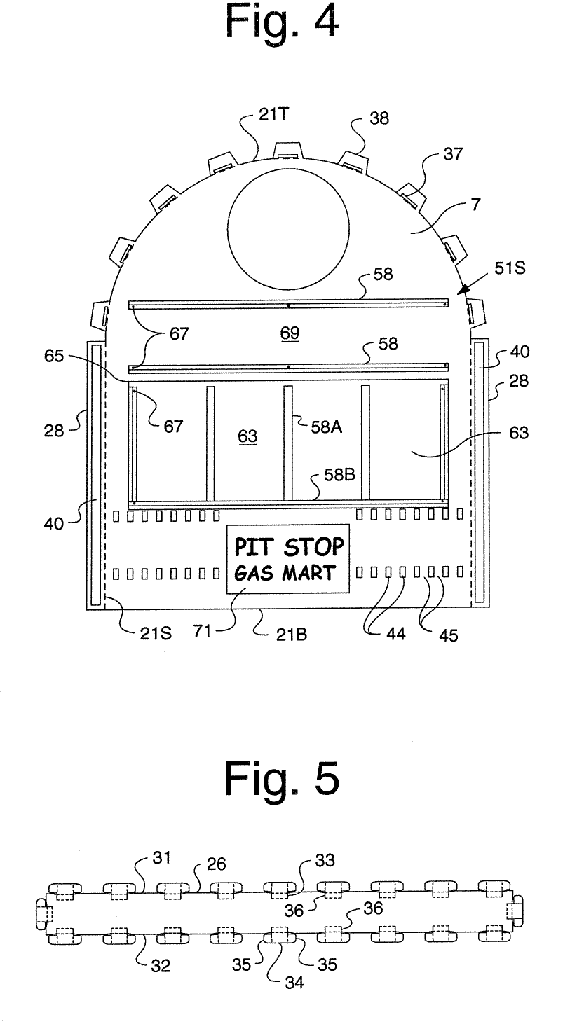

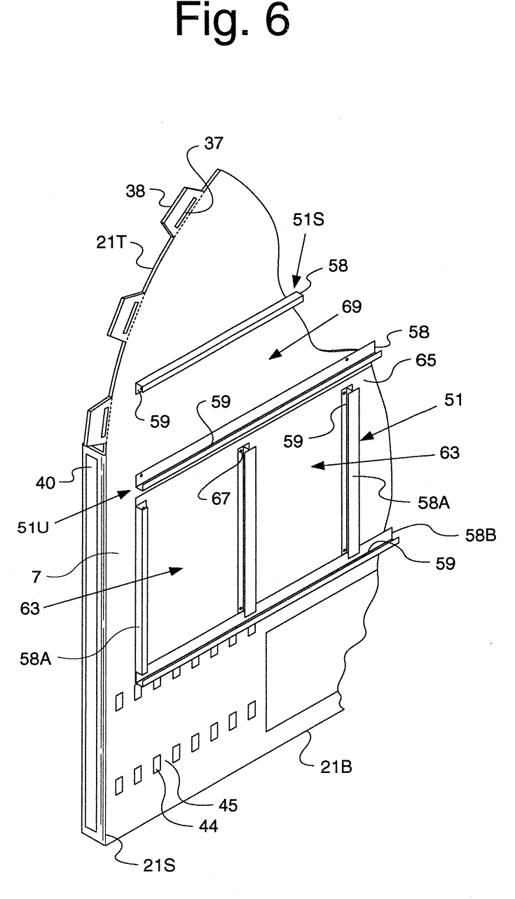

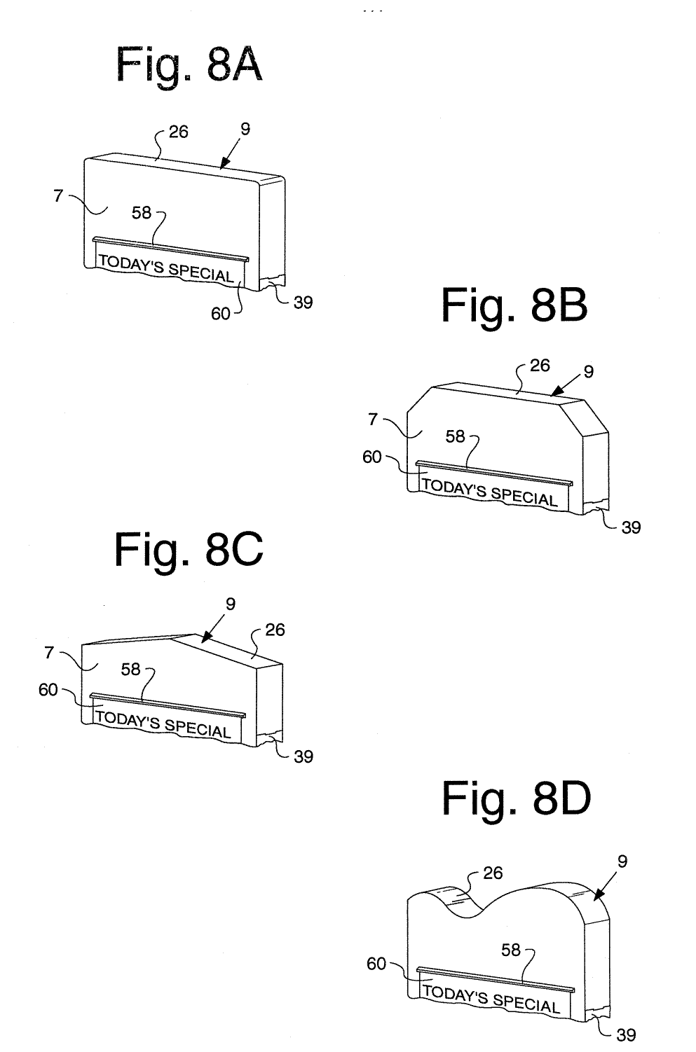

The display panels 7 as best illustrated in FIGS. 1-4 are generally planar and have opposite main surfaces 19 (interior) and 20 (exterior), and top, side and bottom edges designated generally 21T, 21S, and 21B respectively. The edges 21 define the overall shape of the display panels 7 and it is preferred that the display panels 7 be generally the same in size, shape and construction, although different shapes 7 may be utilized together. The display panels 7 in the illustrated structure have a generally straight bottom edge 21B, generally straight side edges 21S and, as shown in FIGS. 1-7, an arcuate top edge 21T. However, for a wide variety of reasons, the top edge 21T may likewise take on any other suitable shape as desired, for example, a substantially straight shape as illustrated in FIG. 8A, a substantially flat shape with one or more sloping sides as illustrated in FIG. 8B, a peaked shape as illustrated in FIG. 8C, a wavy shape as illustrated in FIG. 8D, or any other shape such as a gambrel shape and so forth.

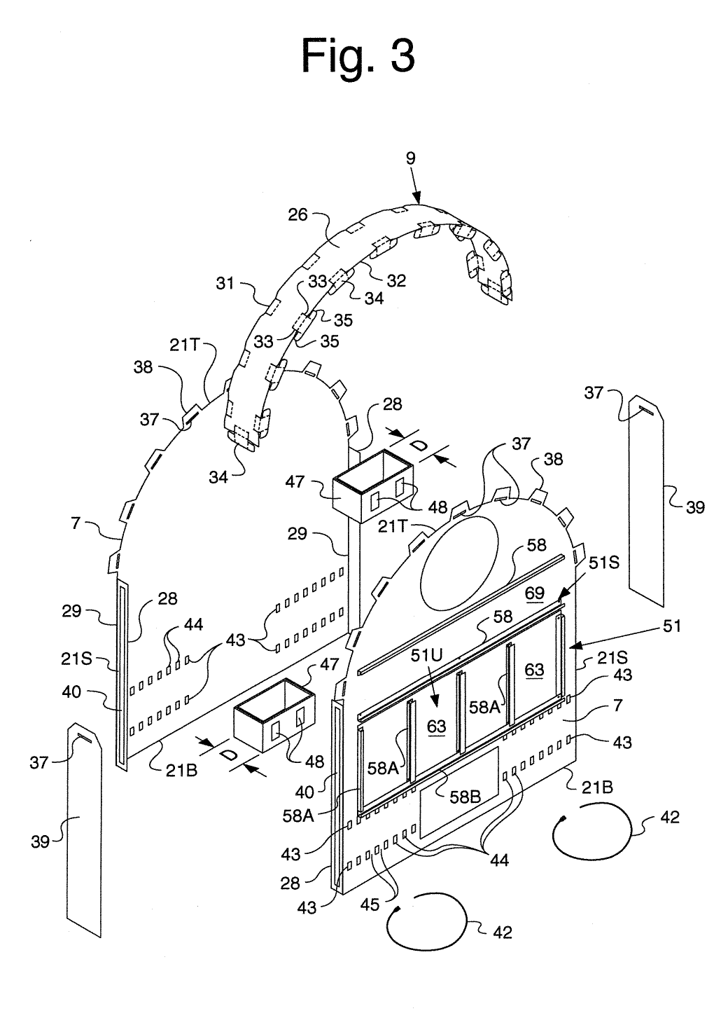

A web structure 9 as best illustrated in FIG. 3 is attached or secured to the opposed display panels 7 and extends therebetween. The web structure 9 increases the moment of inertia of the sign structure and helps provide rigidity thereto. In the illustrated structure, the web structure 9 extends generally around the entire perimeter (except across the bottom 21B) of the sign structure 10 and, in one embodiment, includes a panel member 26 and a pair of web panels 39 as will be further explained. Panel member 26 may be separate from the panels 7 to facilitate the manufacture of the opposed panels 7 and web panel 26. By being separately manufactured, the panel 26 may be bent to conform to a desired shape, for example, to match or conform to the contour of the top edge 21T. In another embodiment, the panel 26 may also have a length sufficient to circumscribe the entire perimeter of the display panels 7 extending from one end at the bottom edge 21B to the opposite end of the bottom edge 21 closing the top and sides while leaving the bottom open. In this alternative embodiment, there would be no need for web panels 39.

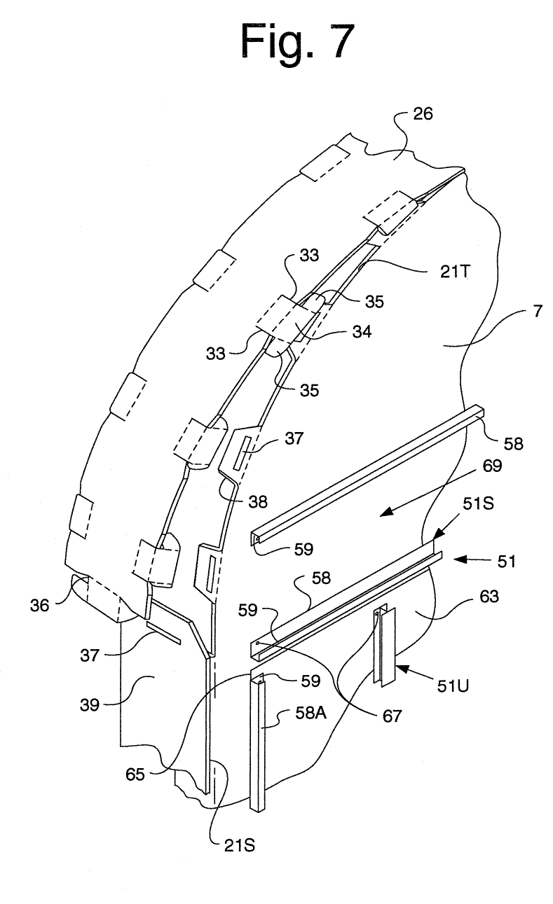

As illustrated in FIGS. 3 and 7, web panel 26 circumscribes only the upper portion of the opposed display panels 7 and terminates at approximately the position where the side edges 21S start. In this illustrated structure, web forming flanges 28 are each preferably integral with a respective panel 7 and extend from a respective side edge 21S. In assembled form, the flanges 28 are generally perpendicular to the panels 7. Although each panel 7, as shown, includes two flanges 28, it is to be understood that other configurations may be provided. The flanges 28, when integral with a respective panel 7, are connected thereto at a respective fold line 29. The width of the flanges 28 is approximately equal to or less than about half the width of the web panel 26.

The display panels 7 with flanges 28 and web panel 26 are formed preferably by die cutting or other means from a suitable material. A preferred material is cardboard or some other suitable board material that is preferably water-resistant. However, other types of material may be used. For example, polymeric panels, metal panels and the like. The material for these parts may be selected based on cost considerations and weather resistance as well as desired life of the display unit 1. The sign structure 10 is formed by attaching the display panels 7 with flanges 28 and panel 26 together by any suitable means. This can be done by adhesion, interlocking elements, welding or the like, depending upon the material selected for forming the sign structure 10. As shown, the sign structure 10 is made out of a weather resistant and printable board-type material.

An effective means of attaching the web panel 26, flanges 28 and display panels 7 together is to have interconnecting attachment elements. As shown, the web panel 26 has opposite side edges 31 and 32 with tabs 34 projecting respectively therefrom. The tabs 34 have ends with opposed ears 35 which are enlarged relative to a throat 36. The tabs 34 may have edge cuts 33 to permit bending inwardly of the side edges of the panel 26 to facilitate attachment of the panel 26 to the panels 7. The display panels 7 will have corresponding slots 37 at ears 38, sized, shaped and spaced each to accommodate a respective tab 34 therein. By use of tabs 34 with the ears 35 being longer than the slots 37, the display panels 7 will resist pulling away from the web panel 26. Although the tabs 34 are shown on the panel 26 and the slots 37 are shown associated with the display panels 7, the slots 37 may be formed in the panel 26 and the tab ears 35 may be formed on the display panel 7. Further, there may be a combination of ears and slots on each of the display panels 7 and web panel 26.

The web panel 26, when secured to the display panels 7, increases the moment of inertia to help resist bending of the sign structure 10 and, in particular, each display panel 7. In the illustrated structure, the web structure 9 further includes web panels 39 having a width approximately equal to the width of the panel 26. The panels 39 are generally planar and each has a length approximately equal to the length of a respective side edge 21S. Each of the panels 39 extends from the end edge of the panel 26 to the bottom edge 21B and is suitably secured to the flanges 28 as, for example, with double sided strips of adhesive tape 40. In this regard, a strip of tape 40 is secured to each of the outside surfaces of the opposed flanges 28 and to the inside surfaces of the panels 39. Each panel 39 is preferably suitably connected to a respective end of such panel 26 through the use of a slot 37 and tab 34 arrangement as previously explained. The panels 39 with associated flanges 28 and web panel 26 substantially close the sign structure 10 (except at the bottom which is closed by the ground) as well as join the display panels 7 together for stability and rigidity purposes. The joined together display panels 7 and web structure 9 form a sign structure 10 with a hollow interior and an open bottom for installation of the display unit as will be hereinafter explained. Alternatively, the flanges 28 may be provided with corresponding slots 37 and ears 34 such that the flanges 28 can be interconnected to connect the opposed display panels 7 together adjacent the bottom edge 21B thereby eliminating the need for panels 39. Other attachment arrangements are also envisioned and anticipated. It is also recognized and anticipated that the display panels 7 and web structure 9 can be formed into a one-piece integral sign structure 10.

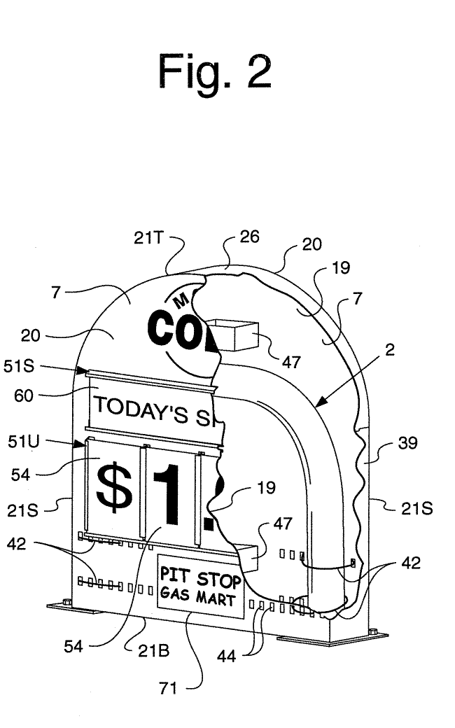

An attachment structure, designated generally 11, is provided to secure the display unit to the guard structure 2. Preferably, the attachment structure 11 is operable to removably attach the display unit 1 to the guard structure 2. As shown, cable ties or straps 42 such as polymeric cable ties of either releasable or non-releasable form may be used. The cable ties 42 capture portions of the sign structure 10 between the ties and the guard structure 2. As best illustrated in FIG. 3, the attachment structure 11 includes a plurality of generally horizontally extending rows 43 of spaced holes 44 having bridges 45 extending between the respective holes. There are a plurality of rows 43 of holes 44 provided in each display panel 7. The rows 43 in one display panel 7 correspond in position generally to the rows 43 associated with the opposed display panel 7 so that respective holes 44 are generally aligned across the sign structure 10. By having a plurality of holes 44 in a row 43, different spacings of the uprights 14A and 14B may be accommodated as well as different shapes and sizes of uprights 14. Stated another way, a row 43 of holes 44 in one panel 7 corresponding to a row 43 of holes 44 in the other panel 7 are similarly spaced at a height and from the edges of the respective display panels 7. The cable ties or straps 42 may then be inserted through at least four of the holes 44 in corresponding rows 43, that is, through at least two spaced holes 44 in each display panel 7 as best illustrated in FIG. 2 such that when the cable tie 42 is tightened, the opposed panels 7 are pulled into engagement with the guard structure 2. This is easily accomplished by threading each cable tie or strap 42 from the back of the unit to the front of the unit through holes 44 located adjacent one side of the uprights 14, looping each cable tie 42 around the front of the unit and threading each cable tie 42 back through corresponding holes 44 located adjacent the opposite of the uprights 14. Both ends of each cable strap 42 should now be extending out the back of the unit. The cable ties 42 can now be tightened to secure the unit 1 to the guard structure and any excess strap material may be either cut off or inserted back into one of the holes 44. The guard structure 2 is now captured between the opposed display panels 7 in the hollow interior of the sign structure 10. Although it is preferred that the cable ties or straps 42 be threaded through both display panels 7 such that both opposed panels 7 are pulled into engagement with the uprights 14 or guard structure 2, it is also recognized that the cable straps can be threaded through just one of the opposed panels 7 and looped around the uprights 14 such that just one panel 7 is pulled into engagement with the guard structure 2.

Although it is generally preferred that the respective height of corresponding rows 43 of holes 44 in the two panels 7 be about the same, it is understood that alignment of the corresponding rows 43 is not critical to the practice of the present invention. The cable ties 42 also preferably have an adjustable length when a loop (FIGS. 2 and 3) is formed thus permitting their use with various sized guard structures 2. The use of cable ties 42 permits the installation by untrained personnel without the requirement of sophisticated tools, equipment or training. The ties 42 may also be easily released either by cutting the tie or, if releasable ties are used, by simply releasing the associated attachment mechanism. Non-releasable ties are preferred to prevent tampering with the display unit 1. Although at least two cable straps 42 should be used with a dual upright guard structure, it is generally preferred that four cable ties 42 be used, two ties positioned in vertically spaced relation around each upright 14 and adjacent a respective side edge of the sign structure 10. Cable ties or straps capable of accomplishing the above-described attachment are well known in the art. Also, it is recognized that the plurality of holes 44 may each include a perforated or scored cutout member (not shown) covering each hole so that only the cutouts associated with the holes 44 through which the cable ties 42 extend are removed when the unit 1 is installed.

Portions of the sign structure 10 adjacent the bottom edge 21B are unsupported in movement of the panels 7 toward and away from one another except at the side edges 21S and in the proximity of the uprights 14A and 14B of the guard structure 2. As best illustrated in FIG. 3, one or more reinforcing spacers 47 having a depth D substantially equal to the spacing between the inside surfaces 19 of the opposed display panels 7 may be provided. Depth D is approximately equal to the transverse dimension of the guard structure uprights 14A and 14B. When used with a guard structure 2 that utilizes a pair of uprights 14A and 14B, a spacer 47 may be positioned between the uprights 14 such that portions of the spacer 47 are in engagement with the display panels 7 to hold them in spaced apart relationship. A three-dimensional solid, for example, a rectangularly shaped device or the like, may be used and may be made by folding cardboard or other similar material to the desired shape. It is preferred that the spacer 47 be attached to the opposed display panels 7, as for example, by double sided adhesive strips 48 either on the interior surfaces of the respective display panels 7 or on the exterior surfaces of the spacer 47. In the event a single upright guard structure is present, spacers 47 may be used on opposite sides of the upright 14. A spacer 47 may also be used in the upper portion of the sign structure 10 to provide further stability and rigidity as illustrated in FIGS. 2 and 3.

As best seen in FIGS. 3, 6, and 7, a holder structure, designated generally 51, is provided for use with interchangeable advertising display members 54 (FIGS. 1, 2). The holder structure 51 may use elongated channel members 58 suitably secured or attached to one or both of the outer surfaces of the opposed display panels 7. The channel members 58 are generally U-shaped and form channels 59. As illustrated, channel members 58 form advertising holders 51U which define upwardly opening pockets 63 and advertising holder 51S which define a side opening pocket 69 for holding display members 54 and 60. The channels 59 are sized to accept therein advertising display members 54 and 60. The upwardly opening pockets 63 are formed by vertically disposed channel members 58A and a single bottom horizontal channel member 58B. A panel 65 may be secured between the channel members 58A and 58B and the display panel 7. Panel 65 may be predrilled with holes to align with holes in the channel members 58A for the receipt therethrough of blind rivets or screw fasteners 67 to secure the channel members 58 and panel 65 to the display panel 7. Such fasteners are well known in the art. An upper side opening holder 51S is provided. As illustrated, two vertically spaced horizontally extending channel members 58 are suitably secured to the display member 7 to form the holder 51S. One or more display members 54 and 60 with advertising indicia thereon may be easily inserted into the vertical pockets 63 or the horizontal pocket 69 and may be of a type well known in the art having various overlying panels with advertising indicia that may be selectively shown. For example, the second from the left advertising display member 54 illustrated in FIG. 1 may be folded cardboard with the subpanels each having a number 1-9 printed on respective portions thereof which by appropriate folding and positioning the appropriate number may be displayed. This permits the changing of the advertising and/or pricing information on the sign structure 10 without having to replace the entire sign structure. The display panels 7 may have printed thereon a house brand while the advertising display members 54 and 60 may have thereon specific advertising information as desired. A store name 71 may also be provided on the display panel 7 via printing or an adhesively mounted sticker.

Thus, there has been shown and described several embodiments of a novel advertising display unit for use with a guard structure, which units fulfill all of the objects and advantages sought therefor. Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. An advertising display unit for attachment to a guard structure comprising:
a pair of generally opposed panels positioned in spaced apart relation having a space therebetween;
a web structure extending between the panels and connected thereto forming a sign structure, said web structure and panels forming a cavity with at least a partially open bottom sized and shaped to receive a guard structure when positioned between the opposed panels; and
an attachment structure adapted to removably secure the sign structure to the guard structure to capture the guard structure between said opposed panels and to retain the sign structure in a generally upright orientation.

2. The advertising display unit set forth in claim 1 wherein the attachment structure includes at least one tie member capturing a portion of at least one of said panels between a portion of the tie member and a portion of the guard structure.

3. The advertising display unit set forth in claim 2 wherein said at least one tie member captures a portion of each of said panels between a respective portion of the tie member and a respective portion of the guard structure.

4. The advertising display unit set forth in claim 2 wherein at least a portion of said at least one tie member is exposed exterior of the sign structure, said exposed tie member portion being accessible and operable for effecting release of the attachment of the sign structure from a guard structure.

5. The advertising display unit set forth in claim 3 wherein said attachment structure further includes a plurality of spaced openings extending through a lower portion of each of said panels, said at least one tie member having portions extending through selected ones of said openings with said captured portion of each of said panels being positioned between said selected openings.

6. The advertising display unit set forth in claim 1 wherein the guard structure includes two upright posts.

7. The advertising display unit set forth in claim 1 wherein said attachment structure includes a plurality of holes positioned in spaced relation in at least one generally horizontal row on each of said panels.

8. The advertising display unit set forth in claim 1 wherein said attachment structure includes a plurality of rows of holes positioned in laterally spaced relation on each of said panels, each row of holes in one panel corresponding to a respective row of holes in said other panel.

9. The advertising display unit set forth in claim 1 wherein said attachment structure includes a plurality of rows of holes positioned in vertically spaced relation on each of said panels, each row of holes in one panel corresponding to a respective row of holes in said other panel.

10. The advertising display unit set forth in claim 1 wherein the web structure is secured to said display panels in a manner to resist bending in a direction generally normal thereto.

11. The advertising display unit set forth in claim 1 wherein the web structure includes a first web panel secured to and extending between the opposed display panels.

12. The advertising display unit set forth in claim 11 wherein one of said first web panel and said display panels includes slots and the other of said first web panel and said display panels includes ears receivable through said slots to attach said first web panel to and between said display panels.

13. The advertising display unit set forth in claim 1 including a spacer positioned adjacent a lower portion of the sign structure, said spacer having a depth approximately equal to the depth of the guard structure and being positioned between said display panels.

14. The advertising display unit set forth in claim 13 wherein the spacer is attached to at least one of said display panels.

15. The advertising display unit set forth in claim 1 wherein the web structure includes a web forming flange portion associated with at least one of the display panels, said flange portion extending in a direction towards the other display panel for attachment thereto.

16. The advertising display unit set forth in claim 15 wherein said web structure includes a first web panel secured to and extending between said opposed display panels, said web forming flange portion extending upwardly from adjacent the open bottom towards said first web panel.

17. The advertising display unit set forth in claim 1 wherein said web structure substantially closes a top portion of the sign structure.

18. The advertising display unit set forth in claim 17 wherein said web structure substantially closes opposite side portions of the sign structure.

19. The advertising display unit set forth in claim 1 including a holding structure located on an exposed face of at least one of said display panels for releasably mounting advertising members to the at least one display panel.

20. An advertising display unit for attachment to a guard structure having at least one upright member associated therewith, said display unit comprising:
a pair of generally opposed display panels positioned in spaced apart relationship relative to each other, each of said display panels including a plurality of openings extending therethrough, the openings associated with one of said display panels being positioned and located in corresponding relationship to the openings associated with said other display panels;
a web structure extending between said display panels and attached thereto, said web structure and said display panels forming an internal cavity adaptable to receive a guard structure when the display unit is positioned thereover; and
attachment means adaptable for extending through selected openings associated with each of said display panels, said attachment means pulling a portion of each display panel into engagement with the at least one upright member associated with a guard structure.

21. The advertising display unit set forth in claim 20 wherein said web structure includes a single web panel attachable to said pair of display panels adjacent the peripheral edge portion thereof.

22. The advertising display unit set forth in claim 20 wherein said web structure includes a first web panel attachable to said pair of display panels adjacent the top portion thereof, and a plurality of second web panels attachable to said pair of display panels adjacent the side portions thereof.

23. The advertising display unit set forth in claim 20 wherein said plurality of openings associated with each of said display panels includes at least one row of spaced openings extending across the lower portion of each display panel, at least some of said plurality of openings being positioned and located so as to lie adjacent to the at least one upright member associated with a guard structure when the advertising display unit is positioned thereover.

24. The advertising display unit set forth in claim 20 wherein said plurality of openings associated with each of said display panels includes a plurality of rows of openings extending across the lower portion of each display panel, at least some of said plurality of rows of openings being positioned in vertically spaced relationship to each other.

25. The advertising display unit set forth in claim 20 wherein said attachment means includes at least one tie member.

26. The advertising display unit set forth in claim 20 wherein said attachment means includes at least one cable strap.

27. The advertising display unit set forth in claim 20 wherein at least one of said display panels includes means for displaying advertising indicia thereon.

28. An advertising display unit for attachment to a guard structure having at least two upright supports associated therewith, the advertising display unit comprising:
a pair of generally opposed display panels positioned in spaced apart relationship to each other;
a web structure extending between said display panels forming a cavity therebetween adaptable for receiving a guard structure when the advertising display unit is positioned thereover;
each of said display panels including a plurality of openings, at least said of said openings being located in the vicinity of the two upright supports associated with a guard structure when the advertising display unit is positioned thereover; and
a plurality of tie members adaptable for securing the advertising display unit to a guard structure, said tie members being insertable through selected ones of said openings associated with each of said display panels so as to attach the advertising display unit to the two upright supports associated with a guard structure, said plurality of tie members pulling a portion of each display panel into engagement with a guard structure.

29. An advertising display unit for attachment to a guard structure comprising:
a sign structure having opposed display panels associated therewith, said sign structure having a cavity formed between said opposed display panels adaptable for receiving a guard structure therewithin;
each of said display panels including a plurality of openings; and
a plurality of tie members positionable within selected openings associated with at least one of said display panels for attaching said sign structure to a guard structure.
